(19) United States
(12) Patent Application Publication
(10) Pub. No.: US 2012/0303730 A1
(43) Pub. Date: Nov. 29, 2012

(54) ENABLING PUBLISHER INITIATED CHATS

(76) Inventor: Zohar Ohana, Jerusalem (IL)

(21) Appl. No.: 13/519,266

(22) PCT Filed: Dec. 25, 2010
(86) PCT No.: PCT/IL10/01084

§ 371 Date: Jun. 26, 2012

Related U.S. Application Data
(60) Provisional application No. 61/290,217, filed on Dec. 27, 2009.

(51) Int. Cl. G06F 15/16

(52) U.S. Cl. 709/206

(57) ABSTRACT

Enabling publisher initiated chats by injecting an application into a publisher's website; identifying a user's entry to the publisher's website; reporting the user's entry to the publisher; allowing the publisher to initiate a chat with the user; and mediating the chat between the publisher and the user.

### BACKGROUND

1. Technical Field

The present invention relates to the field of communications, and more particularly, to user interfaces.

2. Discussion of Related Art

Interactivity between users and publishers as websites is very important for the publishers as means to encourage users to buy products through the website. Commonly users are allowed to initiate contact with the publishers in order to allow the publisher to help the users identify the products they need.

### BRIEF SUMMARY

Embodiments of the present invention provide a data processing system comprising: a mediator server connected via a communication link to a publisher website, the mediator server arranged to: inject an application into a publisher's website; identify a user's entry to the publisher's website; report the user's entry to the publisher; allow the publisher to initiate a chat with the user; and mediate the chat between the publisher and the user.

Embodiments of the present invention provide a method comprising: injecting an application into a publisher's website; identifying a user's entry to the publisher's website; reporting the user's entry to the publisher; allowing the publisher to initiate a chat with the user; and mediating the chat between the publisher and the user, wherein at least one of: the injecting, the identifying, the reporting, the allowing and the mediating is carried out by at least one computer.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIGS. 1 and 2 are high level schematic block diagrams of a data processing system enabling publisher initiated chats, according to some embodiments of the invention; and

FIG. 3 is a high level flowchart illustrating a method enabling publisher initiated chats, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

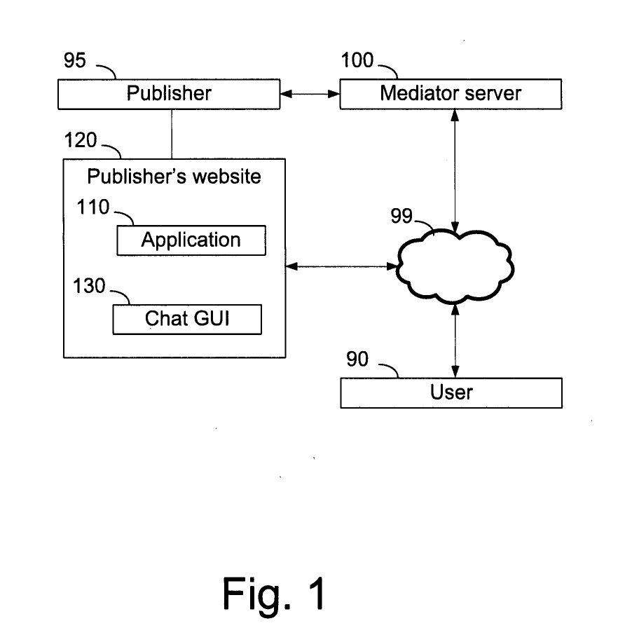

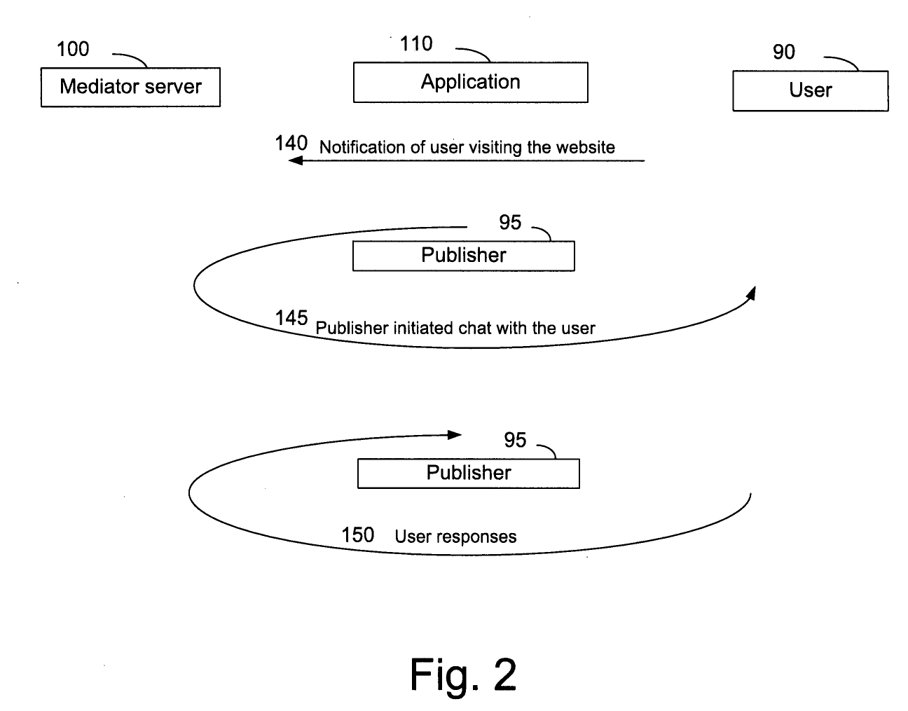

FIGS. 1 and 2 are high level schematic block diagrams of a data processing system enabling publisher 95 initiated chats, according to some embodiments of the invention. The data processing system comprises a mediator server 100, connected via a communication link 99 to a publisher's website 120. Publishers 95 may be allowed to register at mediator server and receive services therefrom. Mediator server 100 is arranged to inject an application 110 into publisher's website 120; to identify a user's 90 entry to publisher's website 120; to report user's 90 entry to publisher 95; to allow publisher 95 to initiate a chat with user 90; and to mediate the chat between publisher 95 and user 90.

Chat management is schematically illustrated in FIG. 2. Application 110 notifies mediator server 100 of users 90 visiting website 120 (140), allows publisher 95 to initiate a chat with user 90 over mediator server 100 (145), and receives user 90 responses to publisher 95 over mediator server 100 (150).

Application 110 may comprise a chat GUI 130 arranged to allow user 90 visiting publisher's website 120 to conduct a chat with a publisher 95's representative via communication link 99 according to a specified profile of user 90. The chat is embedded in publisher's website 120 according to publisher 95's specifications.

Application 110 may further collect data relating to user visits to website 120 and the chats, including statistics relating to time and activities of user 90 and interactions with publisher 95.

Mediator server 100 may manage subscriptions of various publishers 95, and support various usage profiles of publishers 95.

Mediator server 100 may receive user 90 profiles, either through application 100 or from website 120 and adapt chat characteristics accordingly (e.g., GUI 130 design, connection speed, prioritizing users etc.).

Mediator server 100 may support user 90 management in relation to conducted chats, and allow publisher 95 handle a large number of concurrent chats.

Chats may be carried out according to user profiles, stored either at publisher's website 120 or at mediator server 100.

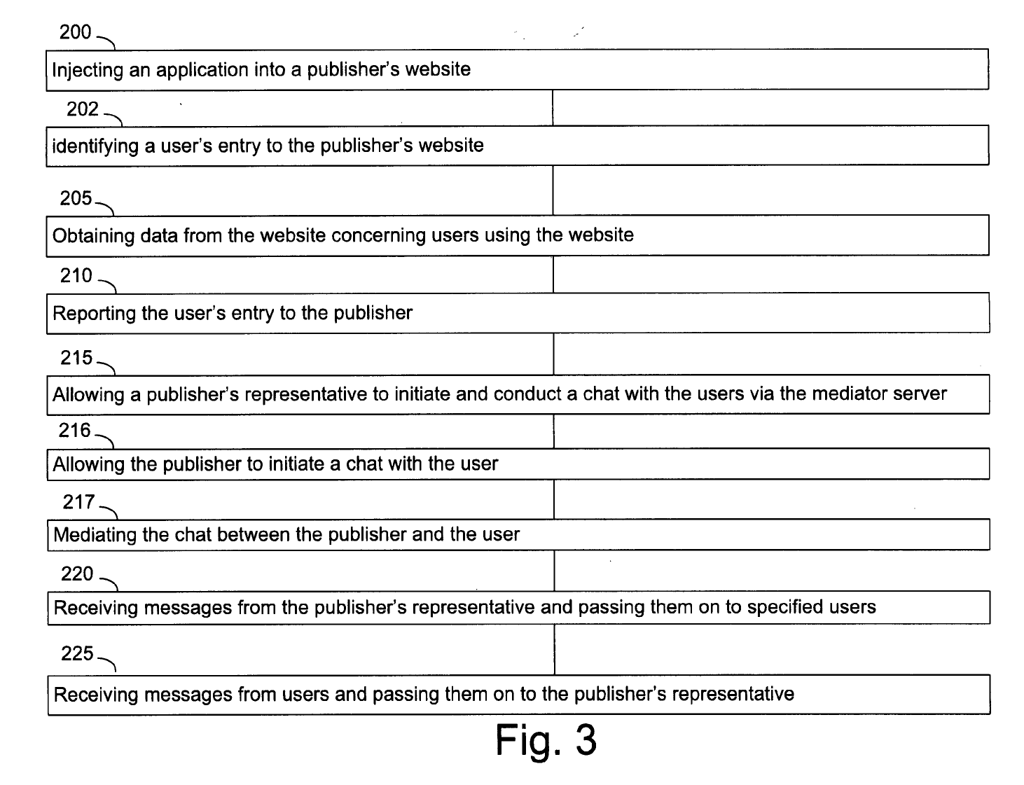

FIG. 3 is a high level flowchart illustrating a method enabling publisher initiated chats, according to some embodiments of the invention. The method comprises the following stages: injecting an application into a publisher's website (stage 200); identifying a user's entry to the publisher's website (stage 202); obtaining data from the website concerning users using the website (stage 205) such as reporting user entries to the publisher (stage 210); allowing a publisher's representative to initiate and conduct a chat with the users via the mediator server (stage 215)—e.g., allowing the publisher to initiate a chat with the user (stage 216) and mediating the chat between the publisher and the user (stage 217) comprising receiving messages from the publisher's representative and passing them on to specified users (stage 220) and receiving messages from users and passing them on to the publisher's representative (stage 225). At least one of the stages 200-225 is carried out by at least one computer.

The method may further comprise allowing the publisher to manage various chats concurrently, follow user actions, optionally in relation to user profiles.

The data processing system and the method may allow the publisher to manage users in a strongly interactive manner, comprising parallel management of users, following user profiles, following repeated visits over time, managing user registrations at the website and publisher subscriptions at the mediator server, as well as analyzing user activities and relating the users to different publisher's representatives.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method comprising:
injecting an application into a publisher's website;
identifying a user's entry to the publisher's website;
reporting the user's entry to the publisher;
allowing the publisher to initiate a chat with the user; and
mediating the chat between the publisher and the user,
wherein at least one of: the injecting, the identifying, the reporting, the allowing and the mediating is carried out by at least one computer.

2. A data processing system, comprising:
a mediator server, connected via a communication link to a publisher website, the mediator server arranged to:
inject an application into a publisher's website;
identify a user's entry to the publisher's website;
report the user's entry to the publisher;
allow the publisher to initiate a chat with the user; and
mediate the chat between the publisher and the user.
